(19) United States
(12) Patent Application Publication
(10) Pub. No.: US 2026/0107890 A1
(43) Pub. Date: Apr. 23, 2026

(54) SYSTEMS AND METHODS FOR GROWING AQUATIC BOTANICAL MATERIAL

(71) Applicant: CH4 Global, Inc., Henderson, NV (US)

(72) Inventors: David Kneen, Melbourne (AU); Anna Loren Hardie, Melbourne (AU); Andrew Christian, Melbourne (AU); Samuel Joseph Cook, Melbourne (AU)

(73) Assignee: CH4 Global, Inc., Henderson, NV (US)

(21) Appl. No.: 19/116,216

(22) PCT Filed: Sep. 28, 2023
(86) PCT No.: PCT/US2023/075380

§ 371 Date: Mar. 27, 2025

Related U.S. Application Data
(60) Provisional application No. 63/411,443, filed on Sep. 29, 2022.

(51) Int. Cl. A01G 33/00

(52) U.S. Cl. CPC A01G 33/00

(57) ABSTRACT

A system for growth of aquatic botanical material includes a basin defining a length, a variable depth, and a width, wherein the width has a substantially parabolic cross-sectional shape.

### CROSS-REFERENCE TO RELATED APPLICATIONS

This application claims priority to U.S. Provisional Application No. 63/411,443 (Attorney Docket: CBH0003MA), filed Sep. 29, 2022, and entitled “SYSTEMS AND METHODS FOR GROWING AQUATIC BOTANICAL MATERIAL,” the disclosures of which are incorporated by reference herein in their entirety.

### BACKGROUND

### Field

The present specification generally relates to systems and methods for growing aquatic botanical material and, more particularly, systems and methods including parabolic basins for growing of aquatic botanical material.

### Technical Background

With up to 1.5 billion domestic cattle worldwide, significant greenhouse gas (“GHG”) contribution globally is from cattle, sheep, and other ruminant production systems that are responsible for up to 20% of total global GHG emissions, primarily through emission of methane. Such methane emission is a bi-product of fermentation of feed organic matter in the rumen of the stomach of the unique digestive system of ruminant animals. It has been found that feed or additives developed using certain aquatic botanical material may lead to reduction of methane emissions.

However, growing such aquatic botanic material may be challenging. For example, growing aquatic botanic material suitable for animal feed may require isolation to avoid contaminants. Moreover, growing the aquatic botanical material with desired characteristics may be challenging or unachievable in typical growth environments. Accordingly, a need exists for systems and methods, which allow for growth of aquatic botanical material to achieve desired characteristics.

### SUMMARY

According to one embodiment, a system for growth of aquatic botanical material includes a basin defining a length, a variable depth, and a width, wherein the width has a substantially parabolic cross-sectional shape.

In another embodiment, a system for growth of aquatic botanical material includes a basin defining a basin volume, a length, a variable depth, and a width, wherein the width has a substantially parabolic cross-sectional shape and one or more environmental adjustment devices configured to adjust one or more environmental characteristics within the basin volume.

In yet another embodiment, a method of growing an aquatic botanical material includes positioning a growth media within a basin volume of a basin defining a length, a variable depth, and a width, wherein the width has a substantially parabolic cross-sectional shape and depositing the aquatic botanical material within the basin volume for a growth period.

Additional features and advantages of the systems and associated methods described herein will be set forth in the detailed description, which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically illustrates a system for growing an aquatic botanical material, according to one or more embodiments shown and described herein;

FIG. 1B schematically illustrates a longitudinal cross-sectional view of the system of FIG. 1A, according to one or more embodiments shown and described herein;

FIG. 1C schematically illustrates and transverse cross-sectional view of FIG. 1A, according to one or more embodiments shown and described herein;

FIG. 2 schematically illustrates a plurality of modules of the system of FIG. 1A, according to one or more embodiments shown and described herein;

FIG. 3 schematically layout of the system of FIG. 1A, according to one or more embodiments shown and described herein; and

FIG. 4 depicts a flow chart illustrating a method for growing an aquatic botanical material, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Reference will now be made in detail to embodiments of the systems and methods for growing aquatic botanical material described herein. According to one or more embodiments, a substantially parabolic tank or pond, herein referred to as a basin, is used to grow aquatic botanical material. An agitator may be positioned within the basin to agitate a growth media and aquatic botanical material positioned therein. In particular, due to the parabolic shape of the basin, agitation may be evenly dispersed throughout the growth media, thereby substantially eliminating unwanted stagnation points, which may otherwise lead to growth inconsistency within the basin. Agitation may encourage growth and characteristic profiles of the aquatic botanical materials to provide improved aquatic botanical materials for purposes such as animal feed, though other applications are contemplated, and possible. For example, substantially even agitation may ensure that the aquatic botanical material equally subjected to stressors to encourage characteristic development, such as increased production of certain chemicals by the aquatic botanical material. That is the quality of the aquatic botanical material may be substantially equivalent throughout the basin. Accordingly, improved quality and consistency of the aquatic botanical material may be achieved. These and additional benefits and embodiments will be described in greater detail herein.

Though it is contemplated that various aquatic botanical material may be grown using systems and methods as described herein, in at least one embodiment, the aquatic botanical material may comprise a macroalgae (e.g., a marine macroalgae) such as those of the Asparagopsis genus, such as Asparagopsis taxiformis or Asparagopsis armata that produce or have the chemical bromoform and/or other halogenated actives. Bromoform and/or the other halogenated compounds when ingested may be useful in reduction of methane gasses within an animal (e.g., cattle, sheep, or other ruminants).

As described herein, “halogenated compound” refers to any chemical compound that includes a halogen (i.e., fluorine, chlorine, bromine, iodine). As described herein, these halogenated compounds are generally present in the glands of some seaweeds. Throughout this disclosure, the description of a “halogenated compound” or “halogenated compounds” may refer to the one or more halogenated compounds that are present in the seaweed, such as specialized seaweed glands, prior to harvest. In some embodiments, the halogenated compounds are organic, generally meaning that the halogen is bonded to a carbon molecular backbone, as would be understood by those skilled in the art. In some embodiments, in downstream processing, the halogenated compound may be bound with a binding agent to provide a “bound halogenated compounds.”

In embodiments, the halogenated compound includes bromine. Without limitation, of particular interest in the present embodiments is bromoform, which has been demonstrated to reduce methane emissions in ruminants when provided in sufficient dosing. However, without being bound by any theory, it is believed that other halogenated compounds, besides bromoform, may also affect methane emission reduction in ruminants, and so the capture of these other compounds may be also beneficial. In additional embodiments, the halogentated compounds may include iodine, which may have an effect of palatability of the animal feed.

Halogenated compounds may include but are not limited to bromoform; dibromo(iodo)methane; bromo(diiodo)methane; iodoform; dibromo(chloro)methane; bromo-chloro-iodomethane; dibromomethane; bromo(iodo)methane; diiodomethane; tetrabromomethane; acetyl iodide; 2-iodoethanol; 1-bromo-2-iodoethane; 2,2-dibromoacetaldehyde; 1-bromopropan-2-one; 1-iodopropan-2-one; 1,1-dibromopropan-2-one; 1-bromobutan-2-one; 1-bromo-3-iodopropan-2-one; 1,1,1-tribromopropan-2-one; 1,1-dibromo-1-chloropropan-2-one; 1,3-dibromobutan-2-one; 1,1-dibromo-3-iodopropan-2-one; 1,1,3,3-tetrabromopropan-2-one; 1,1,1,3,3,3-hexachloropropan-2-one; 1,1,3-tribromopropan-2-ol; 1,1,3,3-tetrabromoprop-1-ene; 1,1,3-tribromo-3-chloroprop-1-ene; 1,1-dibromo-3,3-dichloroprop-1-ene; 1,3,3-tribromo-1-iodoprop-1-ene; 3,3-dibromoprop-2-enal; 4,4-dibromobut-3-en-2-one; 1,4,4-tribromobut-3-en-2-one; 1-iodo-4,4-dibromobut-3-en-2-one; 1,1,4,4-tetrabromobut-3-en-2-one; 1,4,4-tribromo-1-chlorobut-3-en-2-one; 1,1,4-tribromo-4-chlorobut-3-en-2-one; 1,1-dibromo-4,4-dichlorobut-3-en-2-one; 1,4-dibromo-1,4-dichlorobut-3-en-2-one; 2-chloroacetic acid; 2-broroacetic acid; 2-iodoacetic acid; 2,2-dichloroacetic acid; 2-bromo-2-chloroacetic acid; 2-iodo-2-chloroacetic acid; 2,2-dibromoacetic acid; 2-iodo-2-broroacetic acid; 2,2-diiodoacetic acid; 3-chloroprop-2-enoic acid; 2-chloroprop-2-enoic acid; 3-bromoprop-2-enoic acid; 3-iodoprop-2-enoic acid; 3-iodoprop-2-enoic acid; 3,3-dichloroprop-2-enoic acid; 2,3-dichloroprop-2-enoic acid; 3,3-dibromoprop-2-enoic acid; 2,3-dibromoprop-2-enoic acid; 3-iodo-3-dibromoprop-2-enoic acid; 2-iodo-3-bromoprop-2-enoic acid; 2-bromo-3-iodoprop-2-enoic acid; 3,3-diiiodoprop-2-enoic acid; 2,3-diiodoprop-2-enoic acid; 2,3,3-tribromoprop-2-enoic acid; 2,3-dibromo,3-iodoprop-2-enoic acid; 2-iodo-3,3-dibromoprop-2-enoic acid. In some embodiments, halogenated compounds may include compounds as depicted in the table below:

TABLE 1
Additional Halogenated Compounds

| Compound | Structure |
|---|---|
| Halogenated compound 1 | 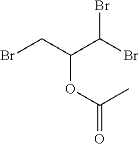 |
| Halogenated compound 3 | 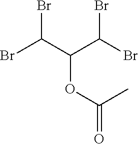 |
| Halogenated compound 3 | 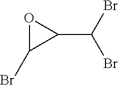 |

It is noted that aquatic botanical material may have or produce any combination of the above compounds and/or other halogenated compounds.

As described herein, some embodiments are directed production of aquatic botanical material (e.g. algae) to provide a seaweed feed product, which may be used as an animal feed or additive to be provided as supplement with, before, and/or after consumption of animal feed. A seaweed feed product, as described herein, refers to any material that is eaten (e.g., consumed and/or digested) by an animal, such as a ruminant, that includes seaweed or processed materials that originated as seaweed. The seaweed feed products described herein, according to various embodiments, may be individually consumed by animals (i.e., the feed is consumed majorly without other feed materials), or may be consumed with other feeds (i.e., the feed is consumed in a mixture with other feed materials or “side-by-side” with other feeds). In some embodiments, the seaweed feed products described herein may constitute a relatively small amount of an animal's overall diet, and may be considered a supplement to another bulk feed. For example, the feeds described herein may be eaten by an animal along with other feeds such as, e.g., forage (including, for example, grass or legume (e.g., alfalfa) forage), silage, corn, soybeans, other seeds, oils, dietary supplements, etc. For example, in some embodiments, the seaweed feed products described herein may be mixed with other feeds such as, e.g., corn and/or soy. In other examples, the animal may graze, or otherwise be provided any of a variety of forage, and be separately fed some amount of the seaweed feed products described herein. It is contemplated that the seaweed feeds described herein may be a portion of a feeding regimen, which may vary by ruminant breed and type, such as dairy cows, beef lot cattle, “high end” cattle (e.g., Wagyu or other higher end cattle types), free range cattle, etc. or may vary by feeding approaches (e.g., feed-lot or grazing systems or a combination of these). Each type of ruminant may have a specialized diet that includes the seaweed feed products along with other additives.

According to various embodiments, the seaweed feed products described herein may be consumed and/or digested by ruminants. As described herein and understood by those skilled in the art, “ruminants” may refer to herbivorous, hoofed mammals (suborder Ruminantia and Tylopoda) that have a complex 3- or 4-chambered stomach. Ruminants include, without limitation, cattle, sheep, deer, goats, giraffes, camels, and llamas. The ruminants described herein may be domesticated, such as ruminants used for direct human food consumption, dairy purposes, and/or recreation. In some embodiments, the ruminants may be dairy cows, beef lot cattle, “high end” cattle such as Waygu, free range cattle, or others or may vary by feeding approaches (e.g., feed-lot or grazing systems or a combination of these).

Accordingly, aquatic botanical materials grown in the systems described herein may be used in the production of animal feed. More particularly, aquatic botanical materials grown in the systems described herein may be used as an additive to animal feed to reduce methane production. In various embodiments, the aquatic botanical materials may go through various subsequent processing and/or formulation steps following growth within the systems described herein.

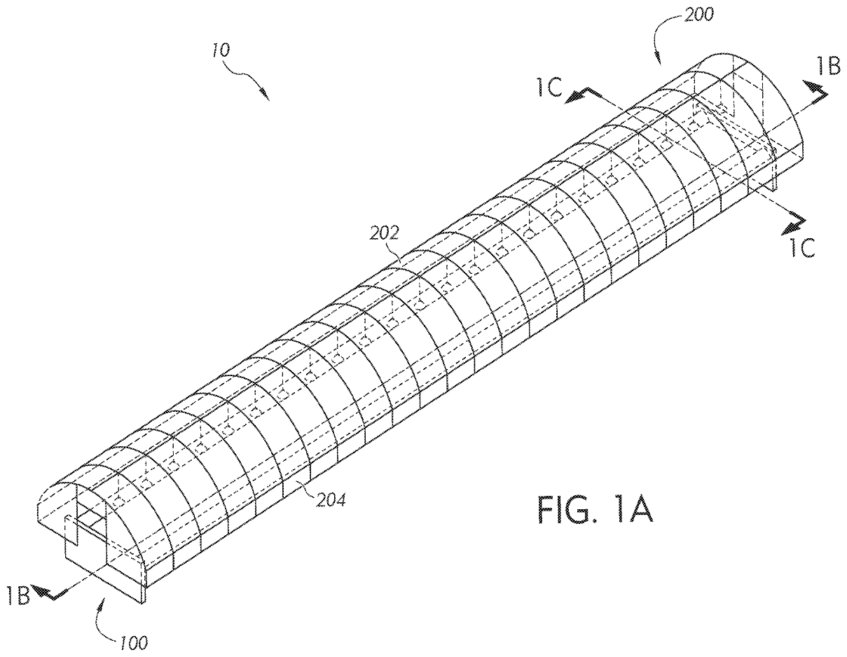

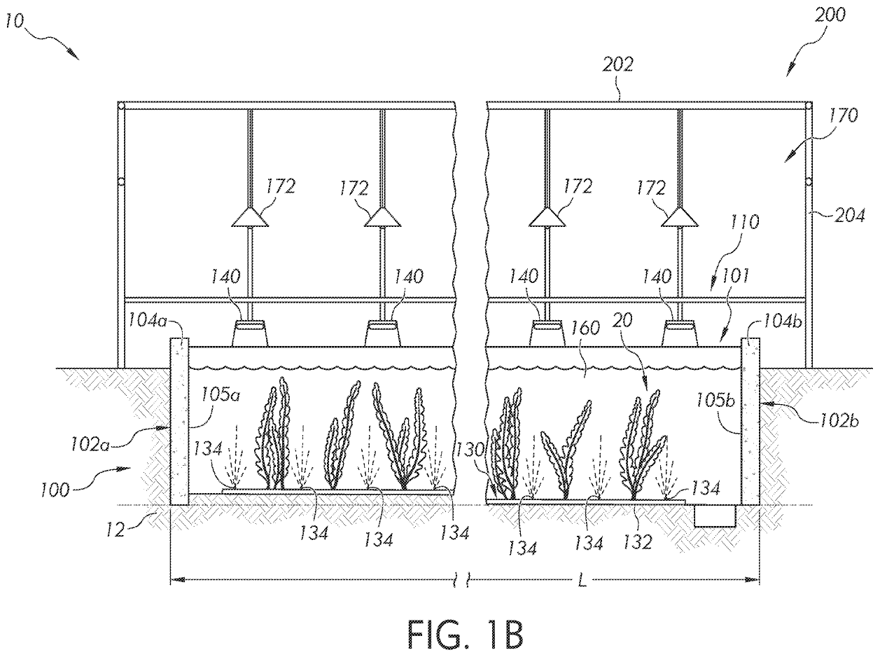

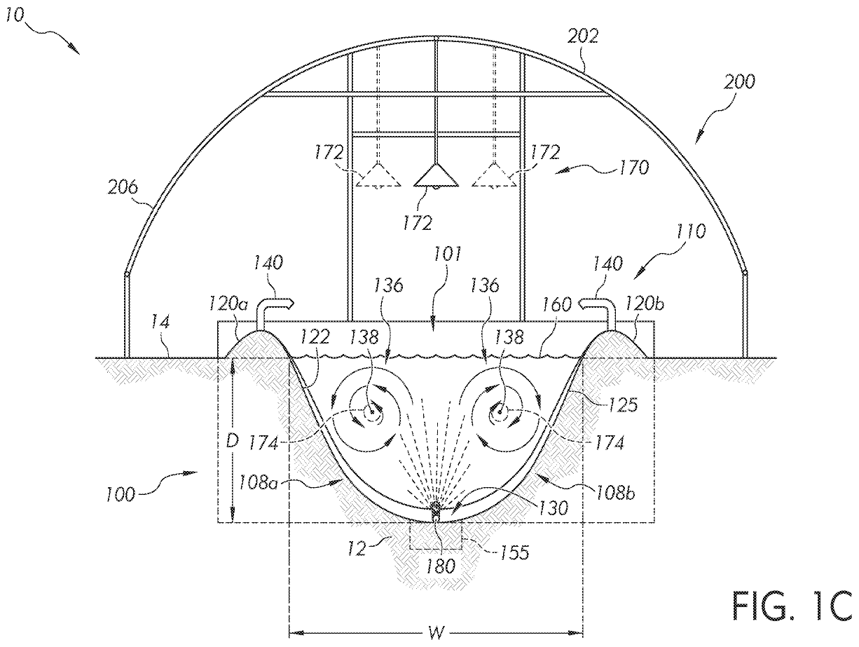

Referring now to FIGS. 1A-IC, a system 10 for growing an aquatic botanical material is generally depicted. For example, the system 10 may generally include a basin 100. Positioned over the basin 100 to substantially isolate the basin 100 from contaminants may be a cover 200. As will be described in greater detail herein, the basin 100 may be particularly suited for growth of aquatic botanical material as opposed to basins used in fish or other wildlife industries.

The basin 100 may be a tank such as formed from any combination of plastic, glass, fiberglass, concrete, or the like. In some embodiments, the basin 100 may be a pond formed within a layer or substrate of earth 14 (e.g., clay, sand, soil, etc.). It is noted that where a basin 100 is a pond, the substrate of earth 14 may provide insulative qualities to growth media 160 and/or aquatic botanical material 20 disposed within the basin 100. For example, the layer of earth 14 may maintain a temperature of the basin 100 (and/or growth media and aquatic botanical material positioned therein) to be between about 40° F. and about 70° F., though other temperatures are contemplated and possible. Where the basin 100 is formed within a layer or substrate of earth, the basin 100 may be made via excavation (e.g., via earthmovers, shovels, etc.) to move and/or carve the substrate of earth to define the basin 100.

In some embodiments, the basin 100 may be positioned near a body of liquid, wherein such liquid may be an aqueous liquid (e.g., fresh water, salt water, or filtered or other processed water), which may be used as or for the creation of growth media 160. For example, in some cases it may be beneficial to form or install the basin 100 within a predetermined range of a body of liquid (e.g., lake, ocean, reservoir, aquafer, etc.). For example, the basin 100 may be formed or installed within 300 miles (483 km) of a body of liquid, such as within 100 miles (161 km) of a body of liquid, such as within 50 miles (81 km) of a body of liquid, such as within 1 mile (1.6 km) of a body of liquid. By positioning the basin 100 closely to a body of liquid, energy used in transporting the liquid (e.g., via a pump, trucking, etc.) may be reduced. In embodiments, the body of liquid may be fluidically coupled to the basin 100 via any combination of piping, pumps, etc.

Referring to FIG. 1B, the basin 100 may generally extend between a first end 102a and a second end 102b to define a length, L. The lengthwise dimension extends in a longitudinal direction. In embodiments, the basin 100 may have any length, L, such as from such as from about 10 feet (“ft”) (3 m) to about 500 ft (153 m) long, such as from about 50 ft (15.2 m) to about 250 ft (76.2 m) long, such as from about 100 ft (30.5 m) to about 200 ft (61 m), such as about 150 ft (46 m) long, though other lengths are contemplated and possible.

Referring to FIG. 1C, a lateral cross-section of the basin 100 is depicted. As illustrated the basin 100 has a width, W. The widthwise dimension extends in a lateral direction. Accordingly, the longitudinal and lateral directions are perpendicular to one another. In the depicted embodiment the basin 100 as a variable depth, D, (in a vertical direction) along with width, W, such that the basin 100 as a substantially parabolic cross-sectional shape, also referred to herein as a parabolic cross-sectional shape for simplicity, in the lateral direction and defines a parabolic surface 122. That is the basin has a curved profile or surface that substantially corresponds to a parabola. In embodiments, the substantially parabolic cross-sectional shape may generally correspond to the following equation:

y=ax²

where a is a coefficient affecting a slope of the parabolic shape. While various slopes are contemplated and possible, in some embodiments a is less than about 1. Such dimension may allow for improved agitation as will be described in greater detail herein. The term “substantially parabolic” is intended to capture minor variations or deviations from the parabolic shape which may be typical of engineering tolerances and may inherently result during manufacturing (such as variations or deviations from the parabolic shape within about 5% or less, such as about 2% or less, about 1% or less, etc.).

Positioned along either longitudinal side of the basin 100 may be a first berm 120a and a second berm 120b. The first berm 120a may be positioned along a first longitudinal side of the basin 100 and the second berm 120b may be positioned along a second longitudinal side of the basin 100. As depicted, the first berm 120a and the second berm 120b are raised relative to a surrounding floor 12. For example, the first berm 120a and the second berm 120b may be raised relative to the floor between about 200 mm and 500 mm such as about 300 mm, though other heights are contemplated and possible. It is noted that in embodiments, the first berm 120a and the second berm 120b may continue the parabolic profile of the basin 100 or may comprise and different or altered profile relative to the parabolic profile.

Referring to FIG. 1B at the first end 102a and the second end 102b may be a first end wall 104a and a second end wall 104b. The first end wall 104a and the second end wall 104b may be formed of any suitable material to close off either end of the basin 100. For example, the first end wall 104 and the second end wall 104b may be formed from a substrate of earth (e.g., clay, sand, soil, etc.), plastic, concrete, stone, or the like. The first end wall 104a and the second end wall 104b may have interior facing surfaces 105a, 105b defining longitudinal ends of a volume of the basin 100. Each of the interior facing surfaces 105a, 105b may be planar as depicted and arranged substantially perpendicular to the longitudinal direction. However, other orientations and/or structures are contemplated and possible. For example, the interior facing surfaces 105a, 105b may be curved, undulating, angled, or the like.

As best depicted in FIG. 1C, the parabolic cross-sectional shape as provided by the parabolic surface 122 of the basin 100 may have a vertex 180 indicating a greatest depth position within the basin 100. The vertex 180 may be generally located at a center of the basin 100 such that the basin 100 is generally symmetrical from left to right. The basin 100 may have any depth suitable for growing aquatic botanical material 20, such as illustrated in FIG. 1B. For example, the basin 100 may have a depth from about 2 ft (0.6 m) to about 100 ft (30.5 m), between such as from about 3 ft (0.9 m) and to about 10 ft (3.1 m), such as about 6 ft (1.8 m) at the vertex 180. It is noted that in growing aquatic botanical material 20, the entire depth need not be filled with growth media 160, but only a portion thereof. The first and second end walls 104a, 104b and the parabolic surface 122 define a basin volume 101. The maximum width within the basin volume 101 may be between about 4 ft (1.2 m) to about 50 ft (15.2 m), between such as from about 6 ft (1.8 m) and to about 15 ft (4.6 m), such as about 12 ft (3.7 m). though other widths are contemplated and possible depending on the depth and the parabolic coefficient.

Positioned within the basin volume 101 may be a liner 125, such as a plastic liner, a geo-membrane liner, or the like. For example, the liner 125 may be formed of a high-density polyethylene. The liner 125 may be a single layer or any numbers of layers. For example, wherein the basin 100 is formed e.g., dug within a substrate of earth 14, the liner 125 may prevent liquid loss through the earthen surface. The liner 125 may be disposed along the parabolic surface 122 and/or the end walls 104a, 104b of the basin 100. In some embodiments, the liner 125 may extend over the first berm 120a and the second berm 120b. Anchors (e.g., rocks, soil, fasteners, etc.) may hold the liner 125 in place. In some embodiments, the first berm 120a and the second berm 120b may be positioned on top of the liner 125. 1750

The liner 125 may be shaped to the basin 100 and extend contiguously with the parabolic surface 122 of the basin 100. For example, the liner 125 may be shaped to be positioned directly adjacent to and extend along a curve of the parabolic surface 122. In some embodiments, an underlayment layer (not shown) may be positioned between the parabolic surface 122 and the liner 125. The liner 125 may have a substantially consistent thickness, for example between about 1 mm and about 10 mm thick, such as about 2 mm thick. However, in other embodiments, the thickness of the liner 125 may vary or increase (e.g., gradually) as the liner 125 approaches the vertex 180. Inclusion of the liner 125 may not substantially alter the substantially parabolic cross-sectional shape of the basin volume 101, so as to maintain desired properties for agitation described in greater detail below. In embodiments, a drain 155 may be formed through the liner 125 and the basin 100 to allow removal of growth media 160.

Growth media 160, which may be an aqueous liquid (e.g., water, salt water, water mixed with one or more compounds (e.g., nutrient compounds)) may be positioned within the basin volume 101 such as on top of the parabolic surface 122 and/or liner 125.

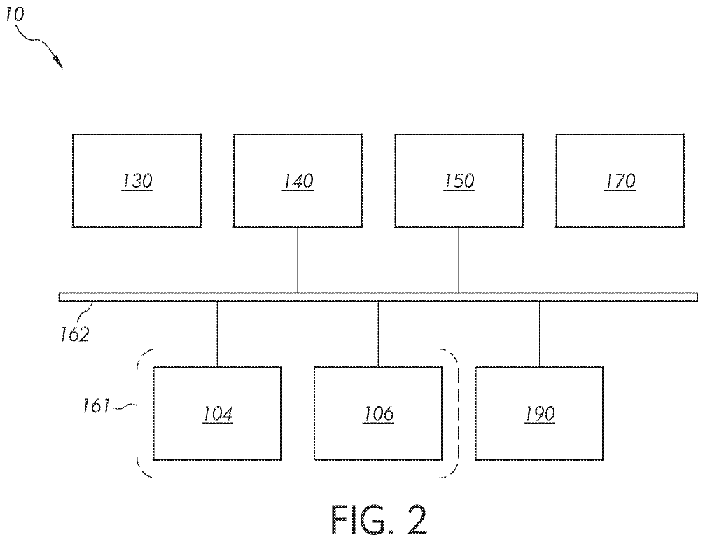

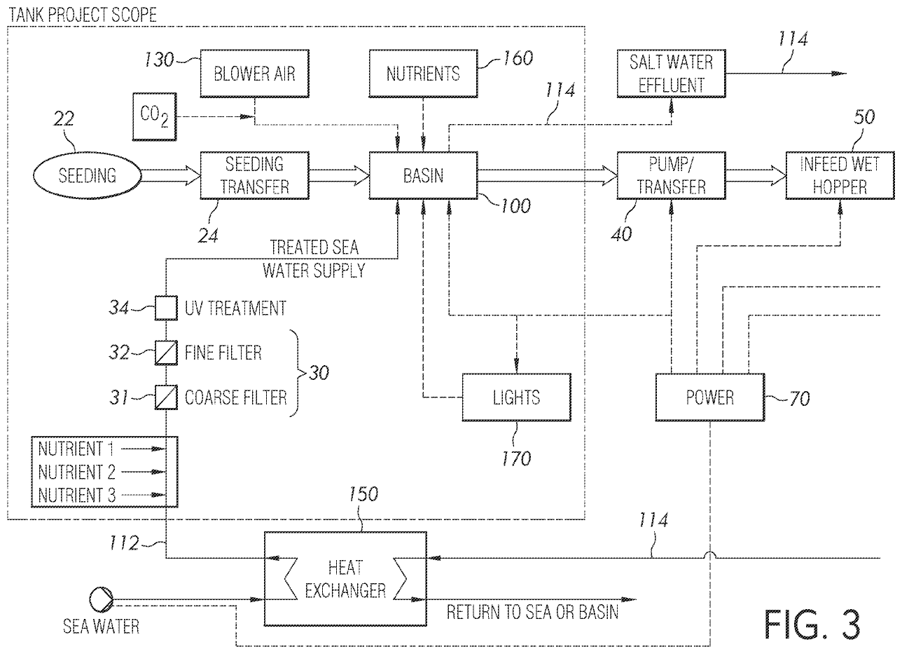

Referring to FIGS. 1B and 1C, the system 10 may generally include one or more environmental adjustment devices configured to adjust the environment within the basin volume 101. For example, the one or more environmental adjustment devices may include one or more agitation devices 130 configured to churn or agitate the growth media 160, one or more temperature adjustment devices 150 (such as schematically illustrated in FIGS. 2 and 3) configured to adjust the temperature of the growth media 160 within the basin volume 101, one or more lighting devices 170 configured to deliver or emit light into the basin volume 101, one or more nutrient inlets 140 configured to deliver nutrients into the growth media 160, or any combination thereof. It is noted that while various environmental adjustment devices are described, the system 10 may include any number of environmental adjustment devices.

As noted above, the one or more environmental adjustment devices may include one or more agitation devices 130 positioned within or on the parabolic surface 122 and/or liner 125 for agitating the growth media 160 within the basin volume 101. The agitation device 130 may be positioned over or at the vertex 180 of the basin volume 101, so as to be centrally positioned within the basin volume 101. The agitation device 130 may extend between the first end wall 104 and the second end wall 104b in one or more sections. The agitation device 130 may be any device configured to agitate the growth media 160 within the basin volume 101. For example, the agitation device 130 may include one or more sparge lines 132 (also referred to as bubblers) extending along the bottom of the basin 100 between the first end wall 104 and the second end wall 104b. The one or more sparge lines 132 may be consecutively placed in a longitudinal direction such that there is substantially consistent agitation along the length of the basin 100. The one or more sparge lines 132 may be configured to release gas (e.g., air, carbon dioxide, oxygen, nitrogen, etc.), which may be pumped into the one or more sparge lines 132 and released via an array of openings 134 into the growth media 160. In some embodiments, multiple sparge lines may be included releasing different gasses. For example, one line may release air while another may release nitrogen or carbon dioxide. In some embodiments, different gasses may be released through the same line as desired.

Due to the parabolic shape of the basin 100, the one or more agitation devices 130 are able to produce substantially consistent agitation throughout the basin volume 101. For example, and as illustrated in FIG. 1C, agitation vortexes 136 may be evenly produced both on both a first side 108a of the basin 100 a second side 108b of the basin 100. The agitation vortexes 136 are schematically illustrated for illustration purposes and would substantially consume both of the first side 108a and the second side 108b of the basin 100 to substantially eliminate stagnation zones within the first side 108a and the second side 108b.

It is noted that while sparge lines 132 are describe above, other agitation devices are contemplated and possible. For example, stirring or churning devices may be positioned within the basin volume 101 and operated to agitate the growth media 160 and any aquatic botanical material 20 being grown therein.

The one or more agitation devices 130 may be mounted within the basin 100 via one or more anchors (e.g., weights, fasteners, or the like). Alternatively, the one or more agitation devices 130 may not be anchored. For example, the one or more agitation devices 130 may be dropped into the basin volume 101 and allowed to descend and/or be adjusted until positioned as desired within the basin volume 101.

As noted above, the one or more environmental adjustment devices may include one or more lighting devices 170, such as a plurality of lighting devices. Lighting devices may include any device capable of outputting light. For example, in some embodiments, the one or more lighting devices 170 may include one or more hanging lights 172, such as one or more arrays of hanging lights 172 arranged over the basin 100. As shown in FIG. 1B, the one or more arrays of hanging lights 172 may be arranged longitudinally over the basin 100. For example, a hanging light may be positioned about every 10 ft, such as about every 5 ft, such as about every 3 ft, etc. Referring to FIG. 1C, in embodiments, there may be a single array of hanging lights 172 positioned over the basin 100 and aligned over the vertex 180 of the basin 100 along the length of the basin 100. In some embodiments, there may be two rows of hanging lights 172. In such embodiments, a row of hanging lights 172 may be positioned over a centroid location 138 of each agitation vortex 136, such as directly over the centroid location 138 of each agitation vortex 136.

In some embodiments, one or more lighting devices 170 may be submerged and/or mounted to one or more structures within the basin 100. For example, one or more lighting devices 170 may be mounted to the liner 125, an agitation device 130, etc. The one or more lighting devices 170 may be mounted using fasteners, clips, or other type anchor devices.

In some embodiments, the one or more lighting devices 170 may include one or more submerged and floating lighting devices 174. The one or more submerged and floating lighting devices 174 may buoyant such that the one or more submerged and floating lighting devices 174 are configured to be submerged and positioned within the growth media 160 at a desired depth below a surface of the growth media 160. For example, the one or more submerged and floating lighting devices 174 may be submerged and positioned approximately at the centroid location 138 of each agitation vortex 136 described above. In some embodiments, the one or more submerged and floating lighting devices 174 may be arranged over and/or along the vertex 180. It is further noted that submerged lighting devices may be positioned anywhere within the basin volume 101. In some embodiments, the one or more lighting devices 170 may include a plurality of submerged lighting devices in various locations within the basin 100.

The various lighting devices 170 described above may include single bulb-type lights or may include strips or tubes of lights. For example, the one or more lighting devices 170 may include, for example, any combination of incandescent, fluorescent, halogen, CFL, LED lights. The various lighting devices 170 may be battery operated or electrically coupled to a power source (e.g., a DC and AC power source). In embodiments, each or some of the one or more lighting devices 170 may be adjustable. For example, brightness of emitted light, wavelength of emitted light, color of emitted light, or the like may be adjustable.

In some embodiments, the position of the one or more lighting devices 170 may be adjustable. For example, in embodiments, including hanging lights 172, one or more of the hanging lights 172 may be height adjustable. For example, a position of the hanging light (e.g., manually, or via a motor or other type actuator) may be lowered closer to the growth media 160 or raised further from the growth media 160. Such adjustment may also adjust the coverage of emitted light.

As noted above, the one or more environmental adjustment devices may include one or more nutrient inlets 140, such as a plurality of nutrient inlets. For example, a nutrient inlet 140 may include a valve which when operated to an open position may be used to deliver nutrients, such as via a pump, into the basin 100 and growth media 160. The one or more nutrient inlets 140 may be positioned at various positions (e.g., such as about every 10 ft, such as about every 5 ft, such as about every 3 ft, of the like) along the length of basin 100. Nutrients may include but are not limited to nitrogen, phosphorus, potassium, or other additives, which may provide improved growth pattern or encourage production of desired characteristics within the aquatic botanical material.

As noted above, the one or more environmental adjustment devices may include one or more temperature adjustment devices 150 (such as schematically illustrated in FIGS. 2 and 3). For example, the one or more temperature adjustment devices 150 may include any number of heating or cooling devices (e.g., heat exchangers) for adjusting the temperature of the growth media 160 within the basin 100. For example and with reference to FIG. 3, the basin 100 may be fluidically coupled to various inlet and outlet lines 112, 114. Coupled to the inlet line 112 may be a temperature adjustment device 150 configured to adjust the temperature of the growth media 160 entering the basin 100. In some embodiments, growth media 160 may be recirculated from the temperature adjustment device 150 or a separate temperature adjustment device to adjust a temperature of the growth media 160 during growth of the aquatic botanical material 20. In some embodiments, air, nitrogen, or other gasses introduced by the sparge line 132 may be adjusted via a temperature adjustment device 150 (e.g., warmed via a heating device or cooled via a cooling device).

In some embodiments, the temperature adjustment devices 150 may include an HVAC unit, which may adjust an air temperature surrounding the basin 100. For example, a top side 110 of the basin 100 may be enclosed by a cover 200, such as a housing 202. The housing 202 may be enclosed to not only isolate the surface of the basin 100 from potential contaminants and also to maintain environmental (e.g., temperature) conditions of the basin 100.

As noted above, positioned around the basin 100 may be a cover 200 to enclose a top side 110 of the basin 100. In some embodiments, the cover 200 may just cover a surface of the basin 100 and/or growth media 160. For example, the cover 200 may be a polymer sheet, though other materials are contemplated and possible. However, in some embodiments, the cover 200 is a housing 202 such as illustrated in FIGS. 1A-1C. For example, the housing 202 may be constructed around the basin 100 to isolate that basin volume 101 and a volume of air surrounding the basin 100 from outside contaminants. In some embodiments, the housing 202 is similar to a greenhouse and may have translucent walls 204. The translucent walls 204 may have a coating applied thereto or otherwise act to filter incoming light (e.g., sun light or ambient light) as desired. In some embodiments, the housing 202 may filter ambient light, such that the filtered ambient light includes green and blue wavelengths and eliminates substantially all other light wavelengths. In some embodiments, the housing 202 may modulate or spread incoming light to ensure consistent lighting across the basin 100. In embodiments, the one or more hanging lights 172 may be mounted to the housing 202. In embodiments, the housing 202 may leave walking space around the basin 100 and/or the first berm 120a and the second berm 120b.

Referring now to FIG. 2, various modules of the system 10 are illustrated as communicatively coupled to one another via a communication path 162. For example, the system 10 may include the communication path 162, a control unit 161 including one or more processors 164 and one or more memories 166, the one or more environmental adjustment devices including the one or more lighting devices 170, the one or more agitation devices 130, the one or more nutrient inlets 140, and the one or more temperature adjustment devices 150 (though additional or fewer environmental adjustment devices are contemplated and possible). Additionally, the system 10 may include one or more sensors 190.

The communication path 162 provides data interconnectivity between various modules disposed within the system 10. Specifically, each of the modules can operate as a node that may send and/or receive data. In some embodiments, the communication path 162 includes a conductive material that permits the transmission of electrical data signals to processors, memories, sensors, and actuators throughout the system 10. In another embodiment, the communication path 162 can be a bus. In further embodiments, the communication path 162 may be a wireless and/or an optical waveguide. Components that are communicatively coupled may include components capable of exchanging data signals with one another such as, for example, electrical signals via conductive medium, electromagnetic signals via air, optical signals via optical waveguides, and the like. Accordingly, the communication path 162 may support wireless and/or wired communication.

The one or more processors 164 may include any device capable of executing machine-readable instructions stored on a non-transitory computer-readable medium. Accordingly, each processor may include a controller, an integrated circuit, a microchip, a computer, and/or any other computing device. There may be multiple processors 164 operable within a disturbed computing arrangement.

The one or more memories 166 are communicatively coupled to the one or more processors 164 over the communication path 162. The one or more memories 166 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memories 166 may be configured to store one or more pieces of logic, as described in more detail below. As noted above, the embodiments described herein may utilize a distributed computing arrangement to perform any portion of the logic described herein.

Embodiments of the present disclosure include logic stored on the one or more memories 166 that includes machine-readable instructions and/or an algorithm written in any programming language of any generation (e.g., 1GL, 2GL, 3GL, 4GL, and/or 5GL) such as, machine language that may be directly executed by the one or more processors 164, assembly language, obstacle-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components. As will be described in greater detail herein, logic stored on the one or more memories 166 and executed by the one or more processors 164 allow the control unit 161 to control operation of one or more of the various environmental adjustment devices described herein to adjust or change an environment within the basin volume 101.

Accordingly, each of the one or more environmental adjustment devices may be communicatively coupled to the control unit 161 to allow the control unit 161 to operate the one or more environmental adjustment devices to adjust an environment of the basin volume 101. For example, and as noted above, the various attributes of the one or more lighting devices 170 may be adjusted by the control unit 161. For example, the control unit 161, executing logic stored on the one or more memories 166, may control operation of the lighting device to adjust the position (e.g., via a motor), brightness, wavelength, etc. Similarly, the control unit 161 may be communicatively be coupled to one or more pumps or motors associated with the agitation device 130 to selectively control agitation of the growth media 160. The control unit 161 may be communicatively coupled to one or more valves and/or pumps associated with the one or more nutrient inlets to selectively deposit nutrients or other material within the basin 100. The control unit 161 may be communicatively coupled to the one or more temperature adjustment devices to cause temperature adjustments within the growth media 160. Other adjustments/actuators are contemplated and possible.

In embodiments, a user input device (not shown), such as any combination of keyboards, touchscreens, knobs, lever, joysticks, etc., may be communicatively coupled to the control unit 161 to allow a user to input desired operational parameters of the one or more environmental adjustment devices. In some embodiments, the control unit 161 may automatically make environmental adjustments based on conditions within the basin 100. As noted above, the system 10 may include one or more sensors 190 communicatively coupled to the control unit 161 via the communication path 162. The one or more sensors 190 may be operable to output a signal indicative of a growth condition or environmental condition within the basin volume 101. Based on that output, the control unit 161 may modify environmental parameters to adjust the environment within the basin 100.

In some embodiments, the one or more sensors 190 may include optical sensors that may be operable to output an optical signal with respect to at least one of light penetration (e.g., through the growth media 160) and growth media reflectance (e.g., surface reflectance). For example, light penetration and/or growth media reflectance may provide information to the control unit 161 with respect to growth patterns, size, etc. of the aquatic botanical material. For example, light penetration and/or reflectance may be reduced as the botanical aquatic media grows. That is, larger plant size or larger aquatic material volume might lead to reduced light penetration and/or reflectance. The optical sensors may be positioned as various positions within the basin 100 and/or above the basin 100.

In some embodiments, the one or more sensors 190 may include, in addition to or lieu of optical sensors, pH sensors, salinity sensors, total dissolved solids (TDS) sensors, turbidity sensors, temperature sensors, or the like. Accordingly, any combination of sensors may be used that are communicatively coupled to the control unit 161 to determine either environmental and/or growth conditions within the basin volume 101. Moreover, the one or more sensors may be located within the basin volume 101 or outside of the basin 100 within the housing 202.

Using feedback from any of the one or more sensors 190, the control unit 161 may adjust the environment using the one or more environmental adjustment devices described herein. For example, agitating the growth media 160 with the one or more agitation devices, moving or otherwise adjusting the one or more lighting devices, adding nutrients or other additives with the one or more nutrient inlets 140, heating or cooling growth media 160 with the one or more temperature adjustment devices 150, etc. For example, during growth phases, such as may be determined via the volume of aquatic botanical material, pH levels, salinity, TDS, etc. nutrient dispensing, agitation, temperature changes, and lighting changes may be adjusted to provide desired growth patterns or characteristics.

In some embodiments, the control unit 161 may be configured to execution of stress scripts stored on the one or more memories 166. Stress scripts may include instructions to adjust the environment of the growth media 160 to stress the aquatic botanical material growing therein. For example, where the aquatic botanical material includes Asparagopsis taxiformis or Asparagopsis armata introduction of stressors (e.g., increasing/decreasing agitation, increasing/decreasing lighting, or other adjustments) may induce stress within the Asparagopsis taxiformis or Asparagopsis armata and encourage increased production of bromoform. For example, increasing stress via agitation, lighting, nutrients, temperature, etc., may cause the Asparagopsis taxiformis or Asparagopsis armata to react in a way that increases production of bromoform and other halogenated materials prior to harvest. In some embodiments, using the one or more sensors described herein, the control unit may detect growth stages (e.g., by the size or structure of the aquatic botanical material) to identify when to apply or run a stress script to increase production of bromoform and other halogenated materials.

Referring now to FIG. 3, a schematic layout diagram of the system 10 is generally depicted. For example, and as noted above, growth media 160 (e.g., water, such as seawater) may be supplied to the basin 100 via an inlet line 112. In some embodiments, the inlet line may include a valve manually or controllably operable via the control unit 161 to allow growth media 160 to flow into the basin 100. The growth media 160 may be passed through a temperature adjustment device 150 (e.g., a heat exchanger) to adjust the temperature of the growth media 160 to a desired temperature. On passing through the temperature adjustment device 150, one or more additions or nutrients may be added to the growth media 160. The growth media 160 may be passed through a filtration system 30 including one or more levels of filtration (e.g., a course filter 31 and/or a fine filter 32). The growth media 160 may be further passed through a UV treatment 34 to kill any microbial life within the growth media 160 prior to depositing the growth media 160 into the basin 100.

Seeding 22 (e.g., seeds) of the desired aquatic botanical material may be provided to the basin 100 via a transfer device 24. For example, the seeding 22 may be transferred to the basin 100 via a pump or via manual or robotic deposit. Once positioned within the basin 100 the various environmental adjustment devices may be operated to adjust the environment within the basin 100 as described herein. Growth media 160 may be circulated out of the basin 100 as waste via a drain 155 formed within the basin 100. Upon completion of the various growth phases, a vacuum 40 may be used to remove the aquatic botanical material 20 from the tank to a hopper 50 or other structure for downstream processing.

A power source 70 (e.g., an AC or DC power source) may be coupled to the various components, (e.g., the one or more lighting devices 170, the one or more agitation devices 130, the one or more temperature adjustment devices 150, the one or more nutrient inlets 140, or the like) to provide power for operation.

It is noted, that while embodiments only depict a single basin, in some embodiments, multiple basins may be included within a system. In some embodiments, each basin may have an independent housing, control unit, sensors, environmental adjustment devices, etc. In other embodiments, multiple basins may be housed within a common housing and may share a common control unit, sensors, and/or environmental adjustment devices.

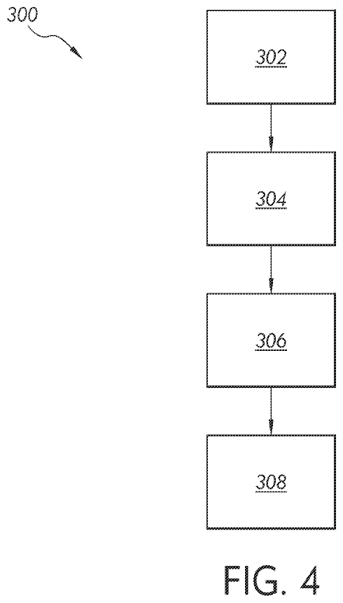

Referring now to FIG. 4, a flow chart depicting a method 300 for growing aquatic botanical material is generally depicted. Though a number of steps are shown, a greater or fewer number of steps may be included without departing from the scope of the present disclose. Furthermore, the method may be performed in any order.

At block 302, the method generally includes positioning a growth media 160 within the basin volume 101 of the basin 100. For example, growth media 160 may be pumped into the basin 100. As noted herein above, before the growth media 160 is positioned within the tank, it may be subjected to heating/cooling, added nutrients, filtering, and/or UV light. At block 304, the method may include depositing the aquatic botanical material 20 within the basin volume 101 for a growth period. For example, and as described above, seeding may be deposited within the growth media 160 and allowed to grow for a growth period.

At block 306, the method may include determining a growth condition of the aquatic botanical material 20. For example determining the growth condition may include detecting one or more characteristics of the aquatic botanical material 20 with the one or more sensors 190. Receiving the feedback from the one or more sensors 190, the control unit 161 may determine a growth condition (e.g., maturity). Based on of the growth condition, the method may include adjusting one or more environmental characteristics within the basin volume 101, at block 308, as described above. For example, the method may include increasing stress on the aquatic botanical material 20 to increase production of, for example bromoform, such as where the aquatic botanical material includes Asparagopsis taxiformis or Asparagopsis armata. For example, increasing stresses about a week before harvest may increase creation of bromoform and other halogenated materials just prior to harvest.

In some embodiments, the method may include forming the basin 100 within a substrate of earth, such as with machinery shovels, or the like, such that the basin 100 has a parabolic cross-sectional shape as described above.

Embodiments of the present disclosure may be further described with respect to the following numbered clauses:
1. A system for growth of aquatic botanical material comprising: a basin defining a length, a variable depth, and a width, wherein the width has a substantially parabolic cross-sectional shape.
2. The system of clause 1, further comprising an agitation device.
3. The system of clause 2, wherein the agitation device is located at a vertex of the substantially parabolic cross-sectional shape.
4. The system of clause 2 or 3, wherein the agitation device is positioned within a basin volume of the basin.
5. The system of any preceding clause, further comprising a liner within a basin volume of the basin.
6. The system of clause 5, wherein the basin comprises a parabolic surface and the liner is disposed adjacent the parabolic surface.
7. The system of clause 5 or 6, wherein the basin comprises a parabolic surface and the liner is disposed contiguous with the parabolic surface.
8. The system of any preceding clause, wherein the substantially parabolic cross-sectional shape substantially corresponds to equation y=ax\hat{ }2, wherein a is a coefficient having a value of less than about 1.
9. The system of any preceding clause, wherein: the basin comprises a first end wall and a second end wall, the length being defined by the first end wall and the second end wall; and an agitation device comprising a sparge line positioned between the first end wall to the second end wall.
10. The system of any of any preceding clause, wherein the agitation device is configured to produce a first agitation vortex on a first side of the basin and a second agitation vortex on a second side of the basin, one or more lighting devices are positioned at a centroid location of each of the first agitation vortex and the second agitation vortex.
11. The system of any preceding clause, further comprising a plurality of lighting devices positioned along the length of the basin, wherein at least one of a brightness of emitted light or a wavelength of the emitted light is adjustable.
12. The system of any preceding clause, further comprising a housing enclosing a top side of the basin, wherein the housing filters ambient light entering the housing, wherein the filtered ambient light primarily comprises green and blue wavelengths.
13. The system of any preceding clause, wherein the basin comprises a first berm along a first longitudinal side of the basin and a second berm positioned along a second longitudinal side of the basin, wherein the first berm and the second berm are raised relative to a surrounding floor.
14. The system of any preceding clause, wherein the basin comprises a substrate of earth defining a basin volume.
15. A system for growth of aquatic botanical material comprising: a basin defining a length, a variable depth, a width, and a basin volume, wherein the width has a substantially parabolic cross-sectional shape; and one or more environmental adjustment devices configured to adjust one or more environmental characteristics within the basin volume.
16. The system of clause 15, further comprising: one or more sensors operable to detect one or more characteristics of the aquatic botanical material within the basin; and a control unit configured to execute logic that causes the control unit to: detect a condition of the aquatic botanical material within the basin based on a signal from the one or more sensors; and adjust the one or more environmental characteristics within the basin with the one or more environmental adjustment devices.
17. The system of clause 16, wherein the one or more environmental adjustment devices comprise an agitation device.
18. The system of clause 17, wherein the one or more environmental adjustment devices comprises a plurality of adjustable lighting devices positioned along the length of the basin, wherein at least one of a brightness of emitted light or a wavelength of the emitted light is adjustable.
19. The system of clause 17 or 18, wherein the one or more environmental adjustment devices comprises a plurality of nutrient inlets positioned along the length of the basin.
20. The system of any of clauses 17-19, wherein the one or more environmental adjustment devices comprises a sparge line releasing a carbon dioxide.
21. The system of any of clauses 17-20, wherein the one or more sensors comprise an optical sensor operable to output an optical signal with respect to at least one of light penetration and growth media reflectance.
22. A method of growing an aquatic botanical material, the method comprising: positioning a growth media within a basin volume of a basin, the basin defining a length, a variable depth, and a width, wherein the width has a substantially parabolic cross-sectional shape; and depositing the aquatic botanical material within the basin volume for a growth period.
23. The method of clause 22, further comprising: determining a growth condition of the aquatic botanical material; and adjusting one or more environmental characteristics within the basin volume based on the growth condition of the aquatic botanical material.
24. The method of any preceding clause, further comprising: receiving a signal from one or more sensors, wherein the signal is indicative of a growth condition of the aquatic botanical material; determining the growth condition of the aquatic botanical material based on the signal; and adjusting one or more environmental characteristics within the basin volume with one or more environmental adjustment devices based on the growth condition of the aquatic botanical material.
25. The method of clause 24, wherein the one or more environmental adjustment devices comprises an agitation device positioned within the basin volume.
26. The method of clause 24 or 25, wherein the one or more environmental adjustment devices comprises a plurality of adjustable lighting devices positioned along the length of the basin.
27. The method of any of clauses 24-26, wherein the one or more environmental adjustment devices comprises a plurality of nutrient inlets positioned along the length of the basin.
28. The method of any preceding clause, further comprising increasing production of bromoform and/or other halogenated materials by the aquatic botanical material by adjusting one or more environmental characteristics within the basin volume.

In should now be understood that embodiments of the present disclosure are directed to systems and methods for growing aquatic botanical material. In particular, embodiments include a basin having a parabolic cross-section shape. As described, due to the parabolic shape of the basin, agitation may be evenly dispersed through the growth media, thereby substantially eliminating unwanted stagnation points. In particular, agitation may encourage growth and characteristics profiles of the aquatic botanical materials to provide improved aquatic botanical materials for purposes such as animal feed, though other applications are contemplated and possible. For example, substantially even agitation may ensure that the aquatic botanical material equally subjected to stressors to encourage characteristics development, such as increased production of certain chemicals by the aquatic botanical material. That is the quality of the aquatic botanical material may be substantially equivalent throughout the tank or pond. Accordingly, improved quality and consistency of the aquatic botanical material may be achieved.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

1. A system for growth of aquatic botanical material comprising:
a basin defining a length, a variable depth, and a width, wherein the width has a substantially parabolic cross-sectional shape.

2. The system of claim 1, further comprising an agitation device.

3. The system of claim 1, further comprising a liner within a basin volume of the basin, wherein the basin comprises a parabolic surface, and
the liner is disposed adjacent the parabolic surface or the liner is disposed contiguous with the parabolic surface.

4. The system of claim 1, wherein:
the basin comprises a first end wall and a second end wall, the length being defined by the first end wall and the second end wall; and
an agitation device comprising a sparge line positioned between the first end wall to the second end wall.

5. The system of claim 2, wherein:
the agitation device is located at a vertex of the substantially parabolic cross-sectional shape;
the agitation device is configured to produce a first agitation vortex on a first side of the basin and a second agitation vortex on a second side of the basin; and
one or more lighting devices are positioned at a centroid location of each of the first agitation vortex and the second agitation vortex.

6. The system of claim 1, further comprising:
a plurality of lighting devices positioned along the length of the basin, wherein at least one of a brightness of emitted light or a wavelength of the emitted light is adjustable; and/or
a housing enclosing a top side of the basin, wherein the housing filters ambient light entering the housing, wherein the filtered ambient light primarily comprises green and blue wavelengths.

7. The system of claim 1, wherein the basin comprises a first berm along a first longitudinal side of the basin and a second berm positioned along a second longitudinal side of the basin, wherein the first berm and the second berm are raised relative to a surrounding floor.

8. The system of claim 1, wherein the basin comprises a substrate of earth defining a basin volume.

9. A system for growth of aquatic botanical material comprising:
a basin defining a length, a variable depth, a width, and a basin volume, wherein the width has a substantially parabolic cross-sectional shape; and
one or more environmental adjustment devices configured to adjust one or more environmental characteristics within the basin volume.

10. The system of claim 9, further comprising:
one or more sensors operable to detect one or more characteristics of the aquatic botanical material within the basin;
a control unit configured to execute logic that causes the control unit to:
detect a condition of the aquatic botanical material within the basin based on a signal from the one or more sensors; and
adjust the one or more environmental characteristics within the basin with the one or more environmental adjustment devices, wherein the one or more environmental adjustment devices comprise:
an agitation device;
a plurality of adjustable lighting devices positioned along the length of the basin, wherein at least one of a brightness of emitted light or a wavelength of the emitted light is adjustable; and
a plurality of nutrient inlets positioned along the length of the basin.

11. The system of claim 10, wherein the one or more environmental adjustment devices comprises a sparge line releasing carbon dioxide.

12. A method of growing an aquatic botanical material, the method comprising:
positioning a growth media within a basin volume of a basin, the basin defining a length, a variable depth, and a width, wherein the width has a substantially parabolic cross-sectional shape; and
depositing the aquatic botanical material within the basin volume for a growth period.

13. The method of claim 12, further comprising:
receiving a signal from one or more sensors, wherein the signal is indicative of a growth condition of the aquatic botanical material;
determining the growth condition of the aquatic botanical material based on the signal; and
adjusting one or more environmental characteristics within the basin volume with one or more environmental adjustment devices based on the growth condition of the aquatic botanical material.

14. The method of claim 13, wherein the one or more environmental adjustment devices comprises:
an agitation device positioned within the basin volume,
a plurality of adjustable lighting devices positioned along the length of the basin, or
a plurality of nutrient inlets positioned along the length of the basin.

15. The method of claim 12, further comprising increasing production of bromoform and/or other halogenated materials by the aquatic botanical material by adjusting one or more environmental characteristics within the basin volume.

16. The system of claim 1, further comprising:
an agitation device;
one or more sensors configured to output a signal indicative of a growth condition within a basin volume of the basin; and
a control unit communicatively coupled to the agitation device and one or more sensors that is configured to:
receive the signal of the growth condition within the basin volume of the basin; and
selectively agitate contents within the basin volume of the basin with the agitation device in response to the signal of the growth condition within the basin volume of the basin.

17. The system of claim 16, further comprising one or more lighting devices communicatively coupled to the control unit, wherein the control unit adjusts the one or more lighting devices in response to the signal of the growth condition within the basin volume of the basin.

18. The system of claim 17, wherein the one or more lighting devices are positioned above the basin and comprise a plurality of adjustable lighting devices positioned along the length of the basin, wherein at least one of a brightness of emitted light or a wavelength of the emitted light is adjustable.

19. The system of claim 5, wherein the agitation device is a sparge line.

20. The system of claim 16, wherein the one or more sensors comprise an optical sensor operable to output an optical signal with respect to at least one of light penetration and growth media reflectance.
